(19) United States
(12) Patent Application Publication
(10) Pub. No.: US 2010/0087194 A1
(43) Pub. Date: Apr. 8, 2010

(54) ENHANCED ZONE DETERMINATION

(76) Inventors: Malcolm David MacNaughtan, New South Wales (AU); Christopher Ridgway Drane, New South Wales (AU); Stephen Frank Brown, New South Wales (AU); Craig Andrew Scott, New South Wales (AU)

Correspondence Address: JONES DAY, 222 EAST 41ST ST, NEW YORK, NY, 10017, US

(21) Appl. No.: 12/450,109

(22) PCT Filed: Mar. 12, 2008
(86) PCT No.: PCT/AU2008/000344

§ 371 Date: Dec. 7, 2009

Related U.S. Application Data
(60) Provisional application No. 60/906,526, filed on Mar. 13, 2007.

(51) Int. Cl. H04W 60/00

(52) U.S. Cl. 455/435.2

(57) ABSTRACT

A method and system for determining whether a mobile radio terminal is in or out of a zone in a radio communications network by relying at least partially on a serving cell identity. The method provides for generating a profile representative of the zone using measurements taken by the mobile radio terminal, the network, and/or using predicted values. A comparison is then made to determine whether the mobile radio terminal is in or out of the zone.

### PRIORITY

The present application claims priority from U.S. Provisional Patent Application No. 60/906,526 entitled “Enhanced Zone Determination”, the entire content of which is hereby incorporated by reference.

### CROSS-REFERENCE TO RELATED APPLICATIONS

The present application is related to the following co-pending patent applications:
PCT/AU2005/001358 entitled “Radio Mobile Unit Location System”
PCT/AU2006/000347 entitled “Enhanced Mobile Location Method and System”
PCT/AU2006/000348 entitled “Enhanced Mobile Location”
PCT/AU2006/000478 entitled “Enhanced Terrestrial Mobile Location”
PCT/AU2006/000479 entitled “Mobile Location”

The entire content of each of these applications is hereby incorporated by reference.

Furthermore, the entire contents of the following references is hereby incorporated by reference. W. C. Y. Lee, Mobile Communications Engineering, McGraw-Hill, 1982, and P. L. H. A. S. Fischer, “Evaluation of positioning measurement systems”, T1P15/97-110, December 1997, and IEEE VTS committee, “Coverage prediction for mobile radio systems operating in the 800/900 MHz frequency range”, IEEE Transactions on VTC, Vol. 37, No. 1, February 1998, 3GPP TS05.08, and C. R. Drane, Positioning Systems, a Unified Approach, Springer Verlag, 1992.

### BACKGROUND

In mobile radio telecommunications systems, it is sometimes desirable to define specific geographic regions associated with services. Such regions are sometimes referred to as zones. In some cases a service provider may choose to only offer a service within such a zone. In other cases the goal may be to modify one or more service parameters within a zone. Yet another application involves charging a different tariff when the user accesses a service from within such a zone.

To define such geographic zones, there are several existing technologies. See, for example, PCT/AU2006/000478.

Compared to existing technologies, the present invention provides certain advantages and/or superior methods for defining and monitoring zones with mobile radio terminals in which the identity of the current preferred access point is used as the primary radio parameter information. In GSM and CDMA networks this access point may be referred to as the serving or camped cell.

There are other existing zone determination systems designed to operate using the identity of the serving cell, sometimes referred to as Cell ID. However, the performance of these systems is limited in several respects. For example, the variability of mobile radio propagation makes the definition of the serving cell list a difficult task. For many applications there is a desire to limit the size of the list in order to constrain the geographical extent of the zone to as small an area as possible. The vagaries of mobile radio propagation makes it difficult in practice to predict which cells may be selected by a mobile terminal as the serving cell whilst situated within the zone. This uncertainty is a problem because the reliability of the determination whilst the phone is actually situated in the zone is important for some applications. Thus maximizing reliability may necessitate defining the zone conservatively by including more than the few nearest cells to provide an extra margin of safety.

Because the determination of whether a mobile terminal is within the zone is made based on the current serving cell, even a brief, statistically unlikely selection of a more distant cell can cause an error or what is sometimes termed an outage. Adopting a conservative approach to reduce outages may require including the next ring of neighboring cells around the zone. However, the penalty associated with this approach is, of course, a larger geographical extent for the zone. In commercial terms, for the users of such systems this may mean additional revenue leakage.

Another difficulty associated with systems employing a list of cells to define a zone arises when the system is required to provide continuous zone monitoring. When a radio terminal is in idle mode, the current serving cell selection is known only at the terminal. As a result the decision process typically has to be implemented at the mobile terminal. The relatively coarse resolution of the input information (i.e., the current serving cell) however can lead to a stability problem when the terminal is placed anywhere in the fringes of a zone. In such areas, due to the dynamically varying radio propagation conditions the terminal may frequently re-select between a cell that is in the zone list and a cell that is not. The result is that the zone status changes along with the reselections. If the application requires that the current zone status be known in the network to operate the service, then every change of zone status must be signaled by the terminal to the network. The potentially high signaling load that can result may be unacceptable due to the excessive network capacity consumed. This may also have a negative impact on a mobile terminal's battery life.

For the foregoing reasons, there is a need for a zone determination and monitoring system and method designed to operate using the identity of the serving cell that enhances zone determination reliability whilst minimizing the signaling load.

### SUMMARY

In one embodiment, the method is characterized by the steps of obtaining a probability (measured, modeled, or any combination thereof) for each of a plurality of cells that the cell will be selected as a serving cell by a mobile radio terminal in the geographic region; and processing at least one probability to generate a profile representing the geographic region. In another embodiment, the method or system is characterized by combining predictions from a modeling tool with measurements made by a terminal within the zone. In some embodiments, by combining the measured values for the strongest cells with predicted values for weaker cells we can achieve greater resolution in treating observations of other neighboring cells. In some embodiments, this can help in preserving zone stability when the terminal is within the zone. This could happen, for instance, when a terminal briefly reselects to a nearby neighboring cell that was not measured as a serving cell during the registration process.

In one embodiment, the method is further characterized by the steps of receiving a plurality of cell identities within the geographic region; and calculating a relative probability that the cell will be selected as the serving cell.

In another embodiment, the method is further characterized by the steps of receiving a plurality of cell identities within the geographic region, selecting some subset of the plurality of cells identities within the geographic region and calculating a relative probability that the cell will be selected as the serving cell for those cells within the subset.

In another embodiment, the method is further is characterized by the steps of determining a received signal power in the geographic region for each of the plurality of cells; determining a signal power variation; and calculating a probability for each of the plurality of cells that the cell will be selected as the serving cell by a mobile radio terminal in the geographic region based on the received signal power and the signal power variation.

In a preferred embodiment, the method is further is characterized by the steps of receiving a plurality of serving cell identities within the geographic region; calculating a relative probability of receiving each serving cell identity; converting each relative probability into a relative received signal power; determining a predicted signal power in the geographic region for each cell; determining a signal power variation; correcting the predicted signal power with the corresponding relative received signal power for each cell; and calculating a probability for each cell that the cell will be selected as the serving cell by a mobile radio terminal in the geographic region based on the corrected signal power and the signal power variation.

In yet another embodiment, the method is characterized by the steps of receiving a serving cell identity; comparing a profile representing the predefined geographic region with the serving cell identity; and determining whether the mobile radio terminal is within the predefined geographic region based on the comparison.

In still another embodiment, the method is characterized by the steps of adjusting a profile representing a geographic region in a radio communications network, the method comprising the steps of obtaining a profile having a probability for each, or a subset of each, of a plurality of cells that each cell is selected as a serving cell by a mobile radio terminal in the geographic region; adjusting a parameter of the profile; and re-calculating a probability for each of the plurality of cells that each cell will be selected as a serving cell by a mobile radio terminal in the geographic region based on the adjusted parameter.

In certain embodiments, the zone determination and monitoring system and method is designed to operate using primarily, substantially, or only the identity of the cell that enhances zone determination reliability whilst minimizing the signaling load.

In certain embodiments the system is characterized by a means for obtaining a probability for each of a plurality of cells that the cell will be selected as a serving cell by a mobile radio terminal in the geographic region; and a means for processing at least one of the probabilities to generate a profile representing the geographic region.

In another embodiment, the system is characterized by a mobile radio terminal configured to receive a serving cell identity; a means for comparing a profile representing a predefined geographic region with the serving cell identity coupled to said mobile radio terminal; and a means for determining whether the mobile radio terminal is within the predefined geographic region based on the comparison coupled to said mobile radio terminal.

In still another embodiment, a system for adjusting a profile representing a geographic region in a radio communications network is characterized by a means for obtaining a profile having a probability for each of a plurality of cells that each cell is selected as a serving cell by a mobile radio terminal in the geographic region; a means for adjusting a parameter of the profile; and a means for re-calculating a probability for each of the plurality of cells that each cell will be selected as a serving cell by a mobile radio terminal in the geographic region based on the adjusted parameter.

### BRIEF DESCRIPTION OF THE DRAWINGS

These and other features, aspects, and advantages of the present invention will become better understood with regard to the following description, appended claims, and accompanying drawings where:

FIG. 1 shows a radio communications network in which a zone is defined;

FIG. 2 shows an exemplary arrangement of the radio network in which the radio signal parameters are collected;

FIG. 3 shows a process flowchart illustrating the method used in generating a profile using measurement data;

FIG. 4 shows a process flowchart illustrating the method used in generating a profile using predicted received signal level data;

FIG. 5 illustrates a cellular network with a defined geographic zone;

FIG. 6 illustrates a radio propagation model of a cellular network including a user's mobile radio terminal;

FIG. 7 shows a process flowchart illustrating the method used in generating a profile using measurement data and predicted received signal level data;

FIG. 8 illustrates a cellular network with an exemplary mobile radio terminal traveling on a route for zone evaluation; and

FIG. 9 illustrates an embodiment of the present disclosure with an adjustment to an antenna orientation in a cellular network.

### DESCRIPTION

The present invention will now be described in detail with reference to one or more embodiments, examples of which are illustrated in the accompanying drawings. The examples and embodiments are provided by way of explanation only and are not to be taken as limiting to the scope of the invention. Furthermore, features illustrated or described as part of one embodiment may be used with one or more other embodiments to provide a further new combination. It will be understood that the present invention will cover these variations and embodiments as well as variations and modifications that would be understood by the person skilled in the art.

Throughout this specification, the term “mobile radio terminal” is used synonymously with terms such as “mobile phone”, “cell phone”, “handset”, “mobile station” or “user equipment” and will be understood to encompass any kind of mobile radio terminal such as a cell phone, Personal Digital Assistant (PDA), laptop or other mobile computer, or pager.

It will be understood that the term “comprise” and any of its derivatives (e.g., comprises, comprising) as used in this specification is to be taken to be inclusive of features to which it refers, and is not meant to exclude the presence of any additional features unless otherwise stated or implied.

In certain embodiments of the present invention, zone reliability is the degree to which, when the mobile radio terminal is in the desired zone, the system correctly returns an in-zone indication.

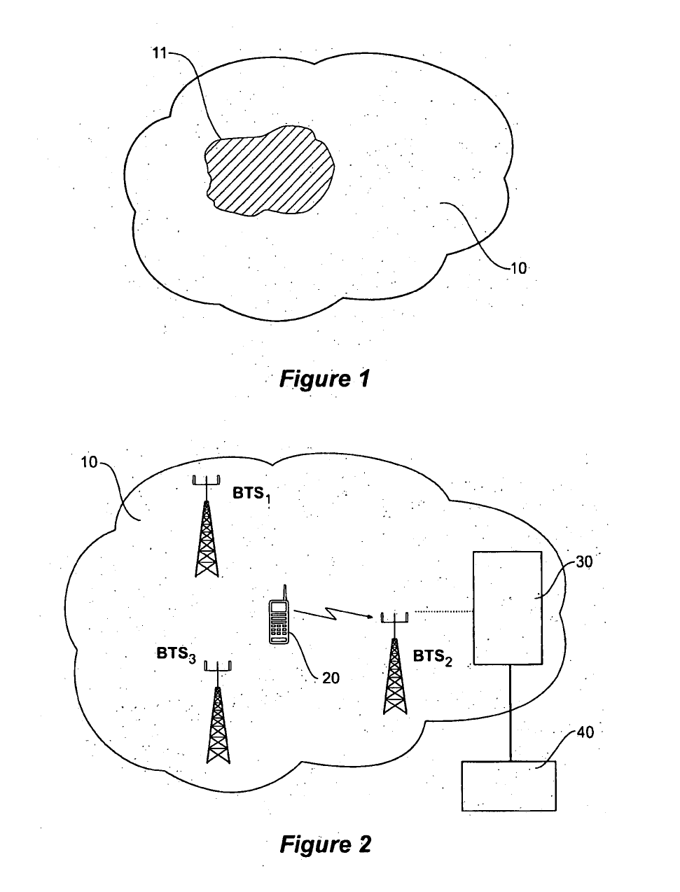

FIG. 1 illustrates a radio communications network 10, in which a region or zone 11 is to be defined. The system according to one aspect of the invention determines whether the mobile subscriber is within the zone or not. From that determination, numerous uses and applications may be used as will be described in more detail below.

It will also be understood that present disclosure may be applied to any application in which a particular region within the radio communications network is required to be defined. This region can include, but is not limited to, a zone as will be understood by the person skilled in the art. While various aspects and embodiments of the present invention will be described with reference to a zone, it will be understood that the invention could be applied to a broader region, or a more narrowly-defined region than in the embodiments defined herein.

In addition to a single zone, multiple zones can be defined and supported simultaneously, including for example, home, work and other zones. In addition a zone could be defined and operated as an exclusion rather than inclusion zone. It is also contemplated that there could be zones within zones or partial overlap of zones.

In one embodiment of the present invention, the zone is defined by a radio parameter profile which includes the following:

(a) a list of one or more elements, each element corresponding to a particular cell in the radio network. Each element in this list comprises (i) the identifier of a cell (ii) the probability that the cell will be selected as the serving cell by a radio terminal while situated in the cell and (iii) a flag indicating whether that particular element is active or disabled;

(b), an unmatched cell probability which represents the probability that the terminal might select as serving cell another cell not featured in the list;

(c) a threshold probability for deciding based on a particular measurement whether the terminal is in or out of the zone; and

(d) at least one filter threshold, used to smooth short-term fluctuations in the zone status, the operation of which will be described below.

The elements of the profile definition may be derived by a combination of measurements or modeling as described in the following subsections. The choice of which method to use may be based on practical considerations such as the availability of suitable radio terminals, the target performance parameters including zone reliability as well as commercial considerations such as the advantages of a customer being able to self-define a zone.

In one embodiment, one option is to determine the zone profile using measurements made within the zone by a user radio terminal. This allows the additional measurements to be taken at many times, including when the mobile is idle. In one aspect, the measurements that may be obtained include the identity of the serving cell. In an alternative aspect, the measurements may include received signal power (RxLev) for mobile radio terminals. The measurement process involves performing one or more measurement cycles whilst the terminal is within the zone. In each measurement cycle the identity of the current serving cell and optionally the RxLev is recorded. Upon completion of the measurement process, the measurements are processed to obtain relative frequencies for each of the resulting set of reported cells.

In a further form of this aspect, the processing of the taken measurement or measurements is conducted at the mobile terminal. This eliminates or reduces the need to transmit the measurements to a remote zone profile processing element, reducing the cost in terms of network capacity and/or further reducing battery power consumption. Probabilities for the profile elements corresponding to the collected measurements may be assigned as shown herein.

When processing is described as being carried out-in a mobile, it will be understood that the processing could be carried out in any combination of the handset, the Subscriber Identification Module (SIM) that is inserted in the handset, an additional processor or smart card inserted into the handset. It will also be understood that much of the processing that occurs in the implementation of various aspects of the present invention can also be distributed, or partially distributed, between the handset, one or more network elements within the radio communications network and/or one or more elements outside the radio communications network.

In another aspect, illustrated in FIG. 2, the mobile radio terminal 20 may make the one or more measurements of one or more signal parameters associated with surrounding cells as previously described, but in this form, the measurements may be communicated to another processor such as a network server for processing the measurements to derive the radio parameter profile corresponding to the zone. FIG. 2 illustrates the arrangement where mobile radio terminal 20 in network 10 communicates its measurements to network server 30, for example via base transceiver station BTS2. The transmission could, for example, be triggered by the subscriber from a menu item on the terminal. An alternative would be for the transmissions to be triggered by a request from the network server on an as needed basis. Any of the above may be used either alone or in combination.

In yet another form, the measurements could be collected by mobile radio terminal 20 and sent to a network server 30, which then sends the measurements either unprocessed or partially processed, to an external processor 40 for complete or further processing. The results of the processing could then be sent to the network server 30 and/or mobile radio terminal 20. In certain embodiments, the external processor 40 may be a third party system or may be part of the service provider's system. Of course any combination of the above or other combinations of data transmission paths could be used.

In yet a further embodiment of the present invention, the measurement or measurements may be obtained by the network 10 itself. In one form, the measurement that may be obtained by the network is the identity of the serving base station. This information may be obtained, for example, from the Home Location Register (HLR) and/or the Visitor Location Register (VLR). Similar measurements may be obtained in other systems such as UMTS as would be known by one of skill in the art. In this embodiment, the processing may be performed in the network server 30 and/or the external processor 40.

The measurement process may, be conducted in several different ways. In one embodiment in which the measurements are to be made by the subscriber's mobile radio terminal 20, the measurement process may be initiated by the subscriber selecting a menu entry on their mobile radio terminal 20. Alternatively the process may be initiated remotely by network based server 30.

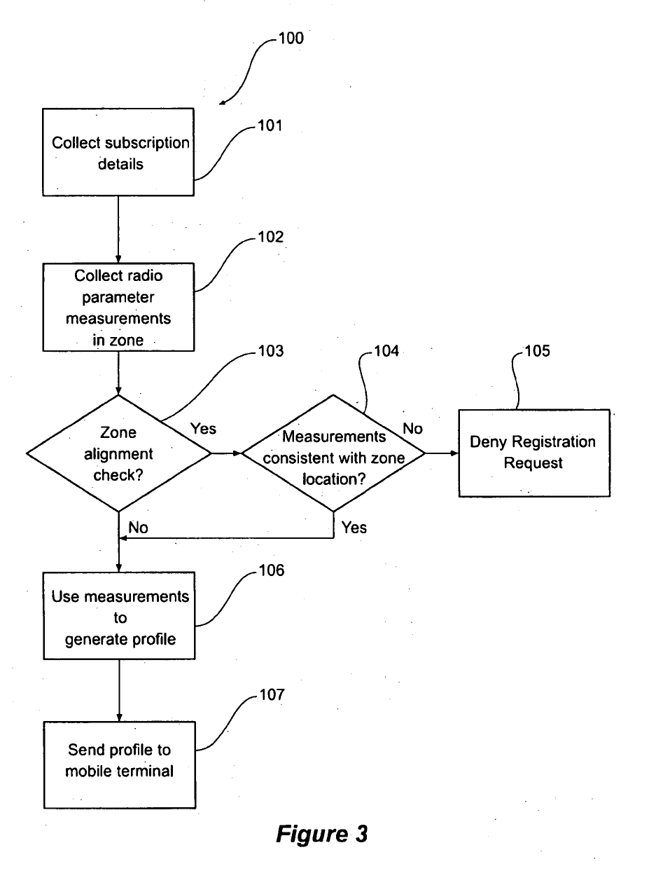

The process of deriving the profile in this embodiment may be as illustrated in FIG. 3. In an optional first step 100, subscription details for the subscriber of the mobile radio terminal are collected. In step 102, the mobile radio terminal collects measurements within its zone or region. The mobile radio terminal may then transmit these measurements to a network processor for example. An optional step 103 is for the network processor to conduct a zone alignment check as described in more detail herein to ensure that the measurements are valid. If the check is done, and the measurements are deemed to be valid in step 104, the system will proceed to generate the profile as described below in step 106. If the measurements are deemed to be invalid (for example, inconsistent with the zone location provided by the subscriber in step 100), the registration request is denied in step 105. Once the profile has been generated, it may be, in this example, sent to the mobile radio terminal. In an alternative embodiment, the mobile radio terminal could store the measurements locally and generate the profile locally. Other combinations of these techniques are also contemplated.

During the measurement process, serving cell measurements reported by the mobile radio terminal 20 are collected repeatedly. These measurements are then used to populate a table containing identifiers for the reported cells. In an alternative embodiment, the associated signal level measurements may also be stored.

In certain embodiments, the measurements may also be considered invalid if the service provider has decided to provide a zone service, for example, based on full Network Measurement Report (NMR) measurements and a user's terminal only supports cell ID measurements. In certain embodiments, the measurement process may be limited in duration. For example, the system may permit the subscriber to roam around in the desired zone for a limited period as described below, during which measurements are collected. This duration may be sufficient for an apartment or small house. By limiting the duration in this way the user is discouraged from making measurements beyond the approximate intended extent of the zone.

For larger zones, the system can be varied to allow the user a larger window of time in which to collect measurements at sample points in the desired zone. The duration may also be varied by the network operator based on different service offerings associated with different sized zones, having different pricing levels or structures. The desired zone sizes may vary depending on the application or service. One way to express the zone size is as a single distance from one side of the zone to the other. For instance in a home zone application, a zone size of between 5 m and 20 m, between 10 m and 30 m, between 20 m and 50 m, between 25 m and 100 m, or between 20 m and 200 m may be used. The reliability of such the zone determinations will be about 50%, about 65%, about 75%, about 80%, 85%, about 90%, about 95%, about 98%, about 99%, or about 99.5%. The above zone sizes may in certain embodiments disclosed herein be combined with any of the above reliability percentages. In this case a time duration between 1 second and 10 seconds, between 5 seconds and 20 seconds, between 10 seconds and 30 seconds, between 20 seconds and 2 minutes, between 30 seconds and 5 minutes, or between 30 seconds and 10 minutes may be used. In another service targeted to large houses or properties, rural settings or farms, complex of buildings, villages, or commercial settings a larger zone size may be suitable, for example from 10 m to 35 m, from 25 m to 75 m, from 40 m to 200 m, from 30 m to 500 m, from 50 m to 1500 m, from 100 m to 2000 m, from 150 m to 2500 m, from 250 m to 3500 m, or from 400 m to 5000 m may be used. The reliability of such the zone determinations will be about 50%, about 65%, about 75%, about 80%, 85%, about 90%, about 95%, about 98%, about 99%, or about 99.5%. The above zone sizes may in certain embodiments disclosed herein be combined with any of the above reliability percentages.

Suitable measurement time intervals may range from 1 second to 10 seconds, 5 seconds to 15 seconds, 10 seconds to 50 seconds, 30 seconds to 3 minutes, 1 minute to 5 minutes, or 2 minutes to 20 minutes. Other zone based services may be targeted at commercial enterprises having offices or other commercial properties. Zone sizes in such cases may range between a few meters and hundreds of meters with corresponding ranges of time required to obtain measurements characterizing the zones.

In some applications, an account representative of the network operator may be responsible for collecting the measurements that define the zone using the mobile radio terminal 20. In this case the system of the present invention provides an alternative mode of operation whereby the account manager has the ability to control the duration of the zone definition measurements. Furthermore, the measurements may also be collected one at a time, at representative points by selecting a menu item to trigger the addition of a new measurement. Between 1 and 5 measurements, between 2 and 8 measurements, between 3 and 10 measurements, between 5 and 20 measurements, between 10 and 50 measurements, or between 25 and 100 measurements may be required to adequately characterize the zone. For larger zones perhaps comprising multiple buildings, rural settings, villages, commercial type complexes Between 1 and 5 measurements, between 3 and 8 measurements, between 5 and 20 measurements, between 10 and 50 measurements, between 25 and 100, between 50 and 250 measurements, between 200 and 1000 measurements, or between 500 and 5000 measurements may be required to adequately characterize the zone. In some applications, it may not be necessary to limit the time or the number of measurements made during the zone initialization. In this case, the user may determine the duration of measuring and the number measurements to be made. A menu entry may be provided on the terminal for example, to conclude the measurement phase. Combinations of various ways to collect measurements are contemplated as well.

For a system where the user is responsible for at least a part of the measurements used in defining the zone, it may be an application requirement to apply checks to ensure that the user has performed the measurements in the area nominated in the service contract. In one aspect, the present invention provides such checks by first applying the measurements to a location system to calculate an estimate of the location from where the user measurements have been made. Examples of methods of obtaining the approximate location of the mobile radio terminal 20 include, but are not limited to those in co-pending patent application numbers: PCT/ AU2005/001358, PCT/ AU2006/000347, and/or PCT/ AU2006/000348.

The results of this calculation can then be compared against the nominal location of the zone (based for example on a geo-code of the nominated street address) and if the two are within an acceptable distance of each other then the registration process proceeds. Otherwise the registration may be rejected or other steps initiated, requiring the user to repeat the registration. What constitutes an acceptable distance may vary from network to network. For example, the average of local cell site separation may be suitable.

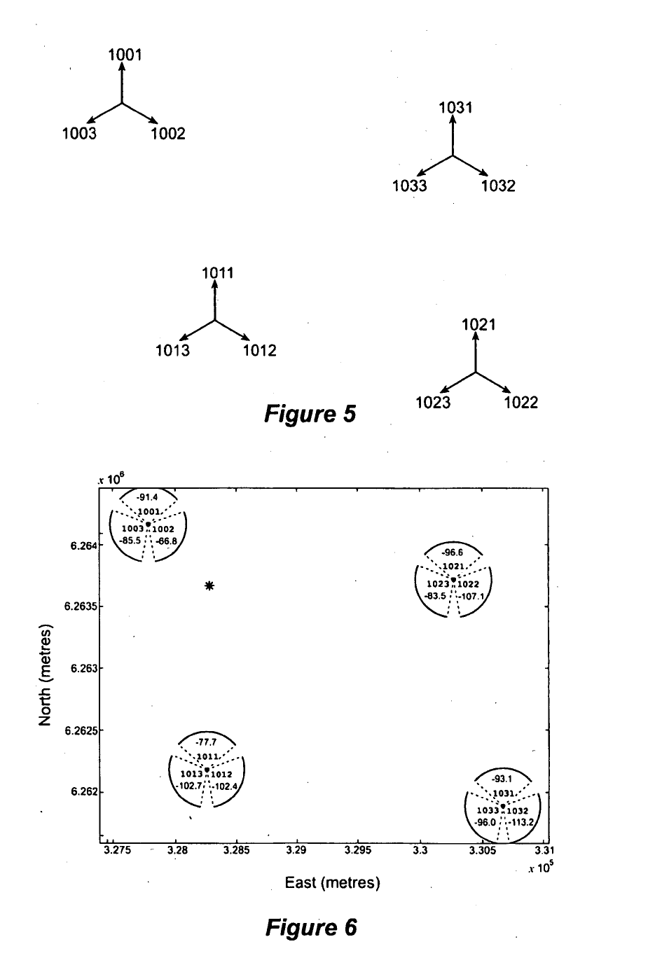

Once the measurement or measurements have been made, a profile representative of the area surrounding the mobile radio terminal 20 is generated. In FIG. 5, an exemplary geographical zone is shaded in which it is desired to offer a particular service, requiring the determination on an ongoing basis as to whether the terminal is within the zone or not. FIG. 5 illustrates a cellular network with an associated radio terminal. Four (4) cell sites are shown, each configured with three (3) sectors. The cell identifiers for the respective sectors are labeled. For the purpose of the example we assume that 20 measurement cycles are carried out Table 1 shows the results of the measurement process. From the relative frequencies observed for each cell, we calculate the serving probabilities shown in the third column.

TABLE 1

| | Number of | |
|---|---|---|
| | cycles in | |
| | which this | |
| | cell was | |
| | selected | |
| Cell | as the | Serving |
| identifier | serving cell | probability |
| 1002 | 13 | 0.65 |
| 1011 | 4 | 0.2 |
| 1023 | 3 | 0.15 |

As a further step, in a preferred embodiment the unmatched probability threshold may be assigned a value of 1/N, where N is the number of measurement cycles performed. Therefore, based on the fact that 20 measurement cycles were completed, in this example the unmatched probability is 0.05. In an alternative embodiment, the unmatched probability may be predefined based on, for example, desired zone reliability. Suitable ranges for some applications may be from 0.0001 to 0.001; from 0.001 to 0.01; from 0.01 to 0.1; or from 0.1 to 0.5.

Thereafter, the probabilities for each of the cells in the profile are normalized in order that the sum of the cell probabilities and the unmatched probability is unity. Table 2 shows the resulting serving cells and associated probabilities.

TABLE 2

| Cell | Serving |
|---|---|
| identifier | probability |
| 1002 | 0.59 |
| 1011 | 0.18 |
| 1023 | 0.14 |

In another embodiment, the profile may be generated entirely by, or substantially by, the radio network propagation modeling. The model may use information on the configuration of the radio network including the location of cell sites, the height and orientation of cell antennas, the radiation pattern of the antennas as well as the channel frequencies and/or any other codes allocated to each cell. The model may also cover the loss in signal power as radio signals travel from transmitter to receiver. Predicted received signal powers may be generated for any or all cells in the network. These power levels may also be used to derive interference level estimates so that the received quality of a signal from any particular cell can be predicted. Examples of the application of network model for predicting received signal levels and interference levels can be found in W. C. Y. Lee, Mobile Communications Engineering, McGraw-Hill, 1982, and P. L. H. A. S. Fischer, “Evaluation of positioning measurement systems”, T1P1.5/97-110, December 1997, and IEEE VTS committee, “Coverage prediction for mobile radio systems operating in the 800/900 MHz frequency range”, IEEE Transactions on VTC, Vol. 37, No. 1, February 1998. Other predictive models may also be possible used.

To create a model, the location of the area in which the desired zone is to implemented is obtained. For example, if the zone is required to service a subscriber's home, the location may be specified as the latitude and longitude corresponding to the home. Alternatively the location may be specified as the civic address of the home and a lookup performed on a lookup table to translate this into the same coordinate frame in which the network cell site locations are defined.

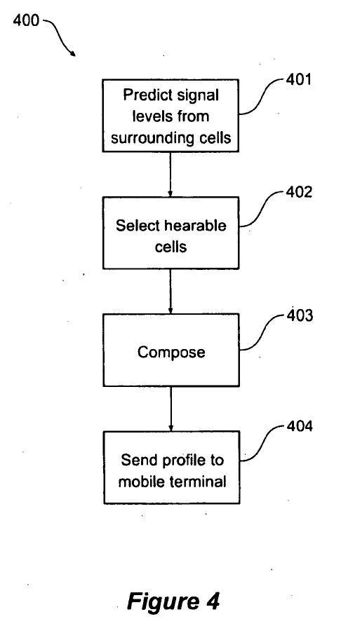

In one embodiment, the profile may, be generated in the server using a network propagation model and then relayed to the mobile radio terminal 20. This process is illustrated in FIG. 4 in which process 400 begins with a prediction of signal level cells in step 401, selects cells for the profile in step 402, generates the profile in step 403 and then sends the profile to the mobile radio terminal 20 in step 404.

Using the model, predictions for all cells within a suitable range of the desired zone may be obtained. Preferably in addition to providing a signal power prediction, the modeling tool can also provide a prediction for the degree of variation that may typically be expected for signals in that area and or a confidence interval around the predictions.

The allowance for the variation in the power levels can be adjusted to account for other variations due to effects such as multipath. One suitable representation for the received signal level is a statistical log normal distribution. The parameters of this model are the mean and standard deviation. Values for the standard deviation typically range between a 2 to 3 dB and 20 dB, depending on the degree of variation anticipated. Optionally the variation may be set differently for different cells based, for example, on their local environment. In a dense urban area larger values would typically be used, for instance between 9 dB and 15 dB, between 12 dB and 20 dB, or between 14 dB and 25 dB. For less dispersive environments or environments with less clutter smaller values may be suitable, for instance between 3 dB and 9 dB, between 6 dB and 12 dB, or between 8 dB and 15 dB. The values may also be varied according to characteristics of the respective cells such as antenna height.

Alternative models include Rayleigh and Rician distributions. These may be suitable depending on the specific application. For example, a zone associated with an indoor or mixed area may be more suitably modeled with a Rayleigh distribution since there is a lesser likelihood of a direct line of sight to the cell antenna. Conversely a zone associated with chiefly outdoor areas may be more suitably characterized with a Rician model. The expected variation may also be suitably represented by other measures such as inter-quartile range.

Having obtained the signal power and variation predictions, the serving probability for each of the cells, or some subset of the cells, in the vicinity of the zone may be calculated by assuming that the serving cell selection process in a mobile terminal operates by simply choosing the strongest cell at any time. In an alternative embodiment, the serving cell selection process may be modeled to take into account mobile radio terminal and radio network variations, for example Preferred Roaming Lists in CDMA systems and the idle cell reselection algorithm parameter settings in GSM and UMTS. Thereby we can calculate the probability for each of the cells that it will be selected as the serving cell whilst the terminal is in the zone. This can be done in the following fashion:

Number the cells 1 through N. Define Rᵢ as the RxLev of the i^{th} cell. Denote p(R₁, . . . , R_{N}) as the joint probability density function of R₁, . . . , R_{N}. From C. R. Drane, Positioning Systems, a Unified Approach, Springer Verlag, 1992, page 77, the probability of the first cell having the highest RxLev (and so being the serving cell), is given by

$${P}_{1} = {\int }_{- ∞}^{∞} d {R}_{1} {\int }_{- ∞}^{{P}_{1}} d {R}_{2} … {\int }_{- ∞}^{{P}_{1}} d {R}_{N} p ( {R}_{1} , … , {R}_{N} ) \qquad ( 1.1 )$$

The probability that the i^{th} cell is the serving cell can be derived from the equation (1.1) by a simple re-arrangement of the terms.

Equation (1.1) is generally applicable to any joint probability distribution function (“p.d.f.”). In our preferred embodiment, we assume that the RxLev's are independent from each other and are given by a standard Gaussian p.d.f.,

$$G ( \frac{{R}_{i} - {\overline{R}}_{i}}{{σ}_{i}} ) \qquad ( 1.2 )$$

where R̅ᵢ is the mean RxLev of the i^{th} cell site and αᵢ is the standard deviation of the i^{th} cell site. Assuming this form for the joint p.d.f., then equation (1.1) becomes

$${P}_{1} = {\int }_{- ∞}^{∞} G ( \frac{{R}_{1} - {\overline{R}}_{1}}{{σ}_{1}} ) d {R}_{1} {\int }_{- ∞}^{{P}_{1}} G ( \frac{{R}_{2} - {\overline{R}}_{2}}{{σ}_{2}} ) d {R}_{2} … {\int }_{- ∞}^{{P}_{1}} G ( \frac{{R}_{N} - {\overline{R}}_{N}}{{σ}_{N}} ) d {R}_{N} \qquad ( 1.3 )$$

After some manipulation, equation 1.3 can be reduced to

$${P}_{1} = \frac{1}{\sqrt{2 {σ}_{1}^{2}}} {\int }_{- ∞}^{∞} {e}^{- \frac{1}{2} \frac{{u}^{2}}{{σ}_{1}^{2}}} Q ( \frac{u - {δ}_{1 , 2}}{{σ}_{2}} ) … Q ( \frac{u - {δ}_{1 , N}}{{σ}_{N}} ) d u \qquad ( 1.4 )$$

where Q(x) is the cumulative distribution function of a standard Gaussian random variable and δ_{1,i}= R̅ᵢ− R̅₁. For i>1 we have that

$${P}_{i} = \frac{1}{\sqrt{2 {σ}_{i}^{2}}} {\int }_{- ∞}^{∞} {e}^{- \frac{1}{2} \frac{{u}^{2}}{{σ}_{i}^{2}}} Q ( \frac{u - {δ}_{i , 1}}{{σ}_{1}} ) … Q ( \frac{u - {δ}_{i , N}}{{σ}_{N}} ) d u \qquad ( 1.5 )$$

where δ_{i,k}= R̅ₖ− R̅ᵢ, with i≠k.

Equations 1.4 and 1.5 expresses the probability of being serving cell as a function of the Rᵢ and αᵢ in a form that is readily and quickly evaluated using standard numerical techniques.

If additional information on the network configuration parameters which affect the serving cell selection is available then these can be incorporated in the probability calculations as well. Such information in GSM systems may include, without limitation, BCCH Allocation lists per cell, C1 and C2 thresholds as well as penalty times. The GSM idle mode cell selection process is described in 3GPP TS 05.08 which is hereby incorporated by reference. In a UMTS system, such information may include, without limitation, Qqualmeas, or Qrxlevmeas. The UE cell re-selection process is described in 3GPP TS 25.304 which is hereby incorporated by reference.

An extension to the use of modeling tools can be used where real measurement data is available for the region of interest. So-called drive-test data if it has been collected in the target zone can be incorporated in the profile generation process. This drive-test data may, for example, provide accurate measurements of shadowing or other deviations in the radio propagation environment. These measurements may be used to further refine the radio propagation model.

The following paragraphs illustrate the process for composing a zone profile in the context of a GSM radio network using a radio propagation model together with the radio network configuration information. FIG. 6 shows a section of a GSM mobile network. Also shown with a dot is the location of a user's mobile terminal. A propagation model is used to predict the received BCCH power from each cell at the center of the zone. These calculated powers are annotated on the plot adjacent to the corresponding cells. The results are also summarized in Table 3 which shows the predicted received power levels for nearby cells received by a mobile terminal situated in the middle of the desired zone. Note that for convenience we have sorted the cells in decreasing order of received power.

TABLE 3

| | Predicted |
|---|---|
| Cell | RxLev |
| ID | (dBm) |
| 1001 | 91.4 |
| 1002 | 66.8 |
| 1003 | 85.5 |
| 1011 | 77.7 |
| 1012 | 102.4 |
| 1013 | 102.7 |
| 1021 | 96.6 |
| 1022 | 107.1 |
| 1023 | 83.5 |
| 1031 | 93.1 |
| 1032 | 113.2 |
| 1033 | 96.0 |

Applying the method described above to the received levels in Table 3, and using a value of 9 dB for the standard deviation of the fading in this area we obtain the serving probabilities associated with each cell as shown in Table 4.

TABLE 4

| | Predicted | Cell |
|---|---|---|
| Cell | RxLev | serving |
| ID | (dBm) | probability |
| 1002 | −66.8 | 0.722 |
| 1011 | −77.7 | 0.160 |
| 1023 | −83.5 | 0.057 |
| 1003 | −85.5 | 0.038 |
| 1001 | −91.4 | 0.010 |
| 1031 | −93.1 | 0.006 |
| 1033 | −96.0 | 0.003 |
| 1021 | −96.6 | 0.002 |
| 1012 | −102.4 | 0.000 |
| 1013 | −102.7 | 0.000 |
| 1022 | −107.1 | 0.000 |
| 1032 | −113.2 | 0.000 |

When using modeling tools to obtain probabilities for cells being selected while within the zone, potentially every cell in the network can be assigned a probability. Clearly cells situated a great distance from the zone will have probabilities very close to zero. In practice, to optimize the computation time for the zone determination it is preferable to limit the number of elements in the profile. This may also be referred to as selecting hearable cells. This can be done by limiting the list to only contain those cells for which the probability exceeds some threshold. One suitable threshold may be the complementary probability to the target zone reliability. An alternative may be the unmatched cell probability. In one preferred embodiment, an average value would be 0.003. However, based on experimentation and simulations, suitable values for the threshold may be between 0.0001 and 0.001, between 0.001 and 0.01, between 0.01 and 0.1, or between 0.1 and 0.5. Another basis for limiting the list may be comparison of the predicted RxLev against a system limitation, for example, receiver sensitivity. In this case cells having a measured or predicted level greater than a threshold level would be retained. One suitable threshold value for the system limitation may be the specified receiver sensitivity of the mobile terminal. Yet another basis for limiting the list is the signal to noise and or interference ratio.

For the present example, Table 5 shows the result after a threshold probability of 0.005 is applied and the probabilities recalculated.

TABLE 5

| | Predicted | Cell |
|---|---|---|
| Cell | RxLev | serving |
| ID | (dBm) | probability |
| 1002 | −66.8 | 0.689 |
| 1011 | −77.7 | 0.183 |
| 1023 | −83.5 | 0.064 |
| 1003 | −85.5 | 0.041 |
| 1001 | −91.4 | 0.011 |
| 1031 | −93.1 | 0.007 |

While the previous example describes an embodiment of the present invention implemented in a GSM network, it should not be construed to limit the invention. For example, one of skill in the art would know that the relevant features described above for a GSM system are virtually identical in 3G systems (e.g., UMTS). Therefore, the above embodiment is equally applicable to a 3G network.

In certain embodiments, Base Station Identification (BASE_ID) and optionally Pilot Power (Ec/10) may be used in a CDMA (IS95) network for example, for zone definition and detection. As with the GSM and UMTS examples a series of measurements may be recorded from within the zone. The measurements may correspond to any combination of the members of the active set, the candidate set, the neighboring set and the remaining set of cells maintained by the mobile terminal. As would be understood by a person of ordinary skill in the art; in a CDMA network, the mobile terminal divides searching into three windows, SEARCH_WIN_A, SEARCH_WIN_N and SEARCH_WIN_R to gather information to support the handover process. In these windows, the mobile terminal gathers information about these four types of cells which collectively include all cells in the network. Much like in the previous exemplary embodiments, appropriate modifications can be made to the data if necessary (e.g., errors can be resolved, cells can be added or removed based on selected criteria etc.) and the data can be compared to a propagation model to detect if the mobile terminal was situated approximately within the zone when the measurements were recorded.

One preferred embodiment is to combine predictions from a modeling tool as with measurements made by a terminal within the zone. One advantage of this embodiment is that if the terminal did not report any measurements of a particular nearby cell, the modeling tool predictions may indicate a sufficiently high probability that the particular cell will still be included in the profile. In addition, using only measured serving cells usually will lead to a relatively small profile containing only those cells with a significant probability of serving. The remaining neighboring cells in this case are not in the profile and as a result have to be treated equally when observed. Intuitively it is clear, however, that those cells which are closer to the zone (although not reported during the few measurement cycles) are more consistent with the terminal being in the zone than other cells a greater distance from the zone. Therefore by combining the measured values for the strongest cells with predicted values for weaker cells we can achieve greater resolution in treating observations of other neighboring cells. This can help in preserving zone stability when the terminal is within the zone. This could happen, for instance, when a terminal briefly reselects to a nearby neighboring cell that was not measured as a serving cell during the registration process.

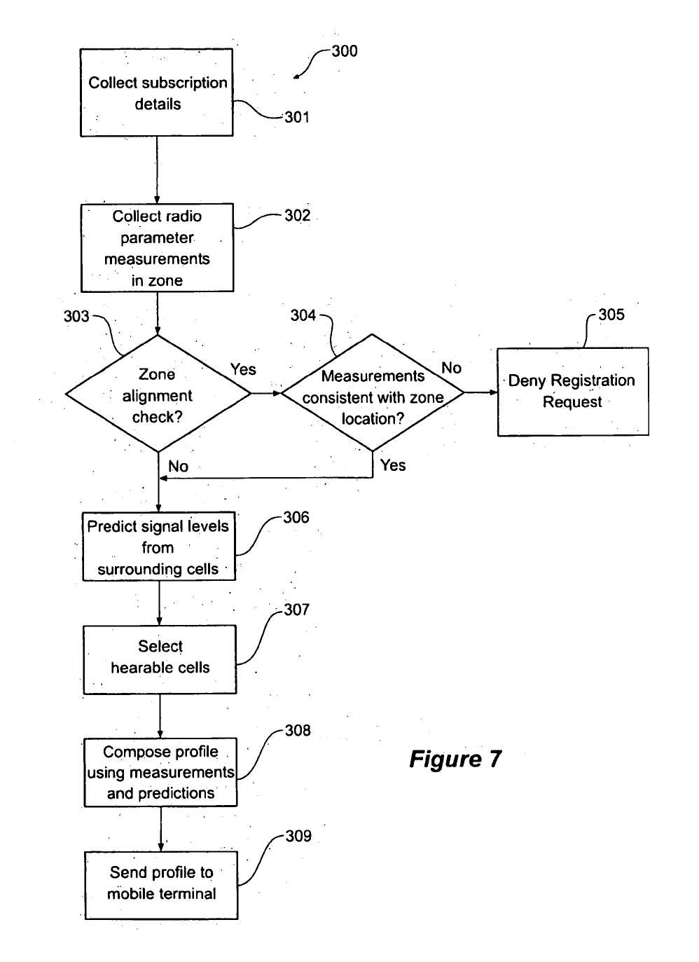

To illustrate the process we take the scenario where a terminal within the zone makes a series of measurements yielding serving counts for particular cells. In an exemplary process 300 illustrated in FIG. 7, the optional step of collecting subscriber details is performed at step 301, and the mobile radio terminal 20 collects radio parameter measurements in its zone at step 302. As in process 100 illustrated in FIG. 3, this process may optionally validate the measurements taken by the mobile radio terminal in steps 303, 304 and 305 as before. In step 306, the system predicts the signal levels from surrounding cells, selects hearable cells in step 307 and generates a profile using both the measurements and predictions in step 308. The generated profile may then be sent to mobile radio terminal in step 309.

The cells and associated counts are detailed in Table 1 above. We also employ a propagation modeling tool to obtain predicted power levels for the cells in the vicinity of the zone, obtaining the levels listed in Table 3 also above.

In order to combine the measured and predicted cells in a common framework we convert the serving probabilities for the measured cells into relative RxLevs, using the fading standard deviation of 9 dB as before. The details of the calculation are shown below. The results of this conversion are shown in Table 6.

TABLE 6

| | # of | | |
|---|---|---|---|
| | cycles in | | |
| | which this | | |
| | cell was | | |
| | selected | | Relative |
| Cell | as the | Serving | RxLev |
| identifier | serving cell | probability | (dBm) |
| 1002 | 13 | 0.65 | 0 |
| 1011 | 4 | 0.2 | −8.7 |
| 1023 | 3 | 0.15 | −10.5 |

We now shift these relative RxLevs to absolute RxLevs by applying the median difference between the relative RxLevs and the predicted RxLevs for the corresponding cells using the propagation model. This preserves the relative offsets between the levels for the measured cells while also aligning the levels with the propagation modeling tool predictions for these cells. The result in this case is shown in Table 7.

TABLE 7

| | Predicted | Corrected |
|---|---|---|
| Cell | RxLev | RxLev |
| identifier | (dBm) | (dBm) |
| 1002 | −66.8 | −69.1 |
| 1011 | −77.7 | −77.7 |
| 1023 | −83.5 | −79.5 |

Combining these received levels with predicted RxLevs for the remaining neighboring cells yields the profile elements shown in Table 8 below.

TABLE 8

| | Predicted | Cell |
|---|---|---|
| Cell | RxLev | serving |
| ID | (dBm) | probability |
| 01002 | −69.1 | 0.612 |
| 01011 | −77.7 | 0.182 |
| 01023 | −79.5 | 0.135 |
| 01003 | −85.5 | 0.044 |
| 01001 | −91.4 | 0.012 |
| 01031 | −93.1 | 0.007 |
| 01033 | −96.0 | 0.003 |
| 01021 | −96.6 | 0.003 |
| 01012 | −102.4 | 0.000 |
| 01013 | −102.7 | 0.000 |
| 01022 | −107.1 | 0.000 |
| 01032 | −113.2 | 0.000 |

Above, we described a processing step in which a set of serving probabilities are converted to relative received power levels in order to be able to integrate them with power level predictions for other nearby cells which were not measured. The following paragraphs present the details of this calculation.

Equations 1.4 and 1.5 define a set of N simultaneous equations. Because the probabilities sum to one, i.e.

$${\sum }_{i = 1}^{N} {P}_{i} = 1 \qquad ( 1.6 )$$

the equations are of rank N−1. Ostensibly, the δ_{i,k}, give N(N−1) unknowns.

However, each vector δᵢ=(δ_{i,1},δ_{i,2}, . . . , δ_{i,i+1}, . . . δ_{i,N})^{T} can be transformed into δ₁ by a matrix transformation, A_{1,i}. This matrix transformation is equal to an N−1 by N−1 identity matrix, with every element of the k^{th} column replaced by minus one. For example, if N=7, then

$${A}_{1 , 3} = [ \overline{\begin{matrix}1 & 0 & - 1 & 0 & 0 & 0 \\ 0 & 1 & - 1 & 0 & 0 & 0 \\ 0 & 0 & - 1 & 0 & 0 & 0 \\ 0 & 0 & - 1 & 1 & 0 & 0 \\ 0 & 0 & - 1 & 0 & 1 & 0 \\ 0 & 0 & - 1 & 0 & 0 & 1\end{matrix}} ] \qquad ( 1.7 )$$

Using these linear transformations, each of the δ₂, . . . , δ_{N} can be translated into δ₁, or (δ_{1,2}, . . . , δ_{1,N}) so there are only N−1 unknowns.

Thus we have a set of equations of rank N−1 with N−1 unknowns. This set of equations can be solved using standard numerical techniques, for example the fminsearch function in Matlab™. If using fminsearch, an appropriate cost function would be

$$C = {\sum }_{i = 1}^{N} ( {n}_{i} - {{Mf}_{i} ( {A}_{i , 1} {δ}_{1 , i} )}^{2} \qquad ( 1.8 )$$

Where nᵢ is the number of times the i^{th} cell was observed to be the serving cell, M is the total number of observations, and ƒᵢ is the function of δᵢ defined by equation 1.5 for i>1 and equation 1.4 if i=1.

In situations where a detailed zone profile has been obtained using the methods, for example, described in PCT/AU2006/000478, such a profile can be adapted for use with a terminal that is only capable of reporting the serving cell by applying the method described above to calculate a serving probability associated with each entry in the profile. As described, for example, in PCT/AU2006/000478, these detailed profiles may be generated by intercepting the Network Measurement Report (NMR) sent by a GSM mobile terminal periodically while in communication with the network. These messages may, for example, be intercepted using signaling probes for instance on the ABIS interface between BTS and BSC in GSM. Alternatively such measurements could be collected by a radio terminal capable of reporting detailed radio measurements via the STK API or other interface. This method might be preferred in order to obtain a more accurate characterization of the zone before using the methods described herein to derive a zone profile for use with radio terminals having only the capability to report the serving cell.

One benefit in using the detailed NMR generated profiles and deriving from them a profile as described in this application is that additional radio terminals (namely those which lack the capability to report detailed radio measurements, providing only the serving cell) can be offered a zone based service. Additionally, compared to a zone profile defined using the methods described above, the greater level of detail used to generate an NMR profile leads to greater fidelity in the resulting CID profile. This will be particularly evident in the probabilities associated with the weaker elements of the profile. When the profile is defined using only serving cell measurements, the RxLevs and corresponding (small) serving probabilities are determined predominantly from model predictions. In the case of an NMR profile however, the actual RxLevs for these weaker cells have been measured and the resulting calculated serving probabilities more closely match the actual probabilities. The improvements that result from the increased fidelity of NMR profiles may be particularly useful, for example, in enterprise zones.

This aspect can be illustrated using an example from the GSM network shown in earlier examples. For this example, we assume that a mobile terminal capable of NMR measurements has been used to obtain an NMR zone profile as disclosed in PCT/AU2006/000478. The resulting GSM NMR zone profile is shown in table 9.

TABLE 9

| Cell | BCCH | | RxLev | Fading |
|---|---|---|---|---|
| ID | ARFCN | BSIC | (dBm) | std dev |
| 1002 | 98 | 16 | −68.0 | 9 |
| 1011 | 91 | 19 | −77.7 | 9 |
| 1023 | 99 | 29 | −83.7 | 9 |
| 1003 | 100 | 19 | −85.9 | 9 |
| 1001 | 87 | 11 | −91.7 | 9 |
| 1031 | 94 | 4 | −93.6 | 9 |
| 1033 | 97 | 33 | −97.8 | 9 |
| 1021 | 95 | 52 | −98.3 | 9 |

Using the method described above to calculate cell serving probabilities from relative

RxLevs, we obtain the values shown in table 10 below.

TABLE 10

| Cell | RxLev | Serving |
|---|---|---|
| ID | (dBm) | probability |
| 1002 | −68.0 | 0.569 |
| 1011 | −77.7 | 0.204 |
| 1023 | −83.7 | 0.094 |
| 1003 | −85.9 | 0.069 |
| 1001 | −91.7 | 0.027 |
| 1031 | −93.6 | 0.020 |
| 1033 | −97.8 | 0.009 |
| 1021 | −98.3 | 0.008 |

Once a zone profile has been defined, the profile can be used to monitor a mobile radio terminal to determine whether it is in the geographic zone. During monitoring, at any given measurement cycle, the terminal reports the current serving cell. A cost is then calculated associated with the current serving cell. If the serving cell is present in the profile, the cost may, be calculated as the probability that the current serving cell would be selected as the serving cell. If the serving cell is not present in the profile, then the cost may be taken as the unmatched cell probability. Alternatively, equivalent processing can be carried out by first taking the natural logarithm of the probabilities. In this case, the cost would be calculated as
−1n(probability) if the serving cell is present in the profile; otherwise the cost would be −1n(unmatched cell probability).

The per cycle cost may be compared with the zone probability threshold to decide whether in this cycle the immediate zone status is IN or OUT. In practice this threshold is adjusted by an amount referred to as the hysteresis offset. This hysteresis serves to provide greater stability to the zone status over time. If the existing zone status is IN, then the zone detection threshold probability is decreased by an amount, typically 5% in order to make it harder to change to an OUT state. In alternative implementations, the probability may be from less than 1% to 5%, 5 to 10%, 10 to 20%, 20 to 30% or from 30 to 50%. Conversely if the current status is OUT, then the zone detection threshold probability is increased by an amount to make it moderately harder to change to IN. In some situations, if the current status is OUT, then the zone detection threshold probability is increased by a small amount to make it moderately harder to change to IN. It should be noted that the adjustments need not be the same. If for instance very high in-zone reliability is desired then the reduction in the probability threshold made while the current state is IN may be greater than the corresponding increase in the threshold when the current state is OUT.

As an example, a typical reliability requirement may be about 99% or greater. This means that in 99 out of 100 experiments, when the mobile terminal is within the zone, the system returns an IN zone determination. In other applications, the in zone reliability may be required to be between 80% and 99.5%, for example, 80% to 85%, 85% to 90%, 90% to 95%, 95% to 99.5%, or 95% to 99.8%.

The example shown below presents both the probability values for the profile elements as well as the corresponding costs which are calculated as −1n(probability). The thresholds are defined in this logarithm space.

FIG. 8 and Table 11 provide an example to illustrate the zone detection processing. FIG. 8 shows the radio network configuration and the zone as described previously. A route has been marked on the figure along which the user moves while carrying a mobile terminal. Several points have been labeled along this route at which the zone status evaluation will be illustrated. The rows of the table correspond to these successive measurement and evaluation points. The first column shows the cell ID of the serving cell reported by the terminal in the corresponding cycle. The next column shows the probability of that cell in the profile. The next shows the calculated cost and the subsequent column shows the threshold. The final column shows the corresponding zone status without taking into account any filtering to smooth the decision process.

TABLE 11

| Serving CID | Probability | Cost | Threshold | Status |
|---|---|---|---|---|
| 1043 | 0.0003 | 8.00 | 3.32 | OUT |
| 1031 | 0.0068 | 4.99 | 3.32 | OUT |
| 1002 | 0.6894 | 0.37 | 3.68 | IN |
| 1002 | 0.6894 | 0.37 | 3.68 | IN |
| 1002 | 0.6894 | 0.37 | 3.68 | IN |
| 1011 | 0.1833 | 1.70 | 3.68 | IN |
| 1011 | 0.1833 | 1.70 | 3.68 | IN |
| 1012 | 0.0003 | 8.00 | 3.32 | OUT |

The output from the immediate zone status determination at each cycle is applied to a filter which is designed to suppress short term variations caused by brief re-selections. In some embodiments at least one filter threshold is used to smooth short-term fluctuations in the zone status. In other embodiments at least a plurality of filters is used to smooth short-term fluctuations in the zone status. This filter may be referred to as a debouncer, or an anti-hunting filter and may be implemented in a number of ways. For example, hysteresis could be used to filter the current zone status determination signal so that the output determination takes recent history into account. The filter could also take into account, for example, the difference between the immediate cycle cost and the log probability threshold.

The debouncer could be implemented, for example, in software as a feedback loop with a memory of past outputs. As each zone status determination is made, the memory could be updated correspondingly with the current determination. This memory would provide an input to the filter for subsequent determinations. This could operate as a moving window average, taking the costs computed in a series of cycles to compute an average cost before comparing the resulting average cost against a cost threshold to determine the status. The software could execute in any combination of the handset, the Subscriber Identification Module (SIM) that is inserted in the handset, an additional processor or smart card inserted into the handset. Alternatively, the debouncer could be implemented in hardware.

When the zone status is determined to have changed, this may be signaled to a network based server using a variety of means including SMS, USSD or other wireless bearer. Transmitting the information only on a change of status yields low signaling rate which in turn minimizes battery drain in the subscriber's terminal. Other events may be used to trigger the transmission of the zone status to the network. For example, the transmission could be triggered by the subscriber initiating a call, thereby sending the information when it is required to determine the zone status for rating a call. The act of unlocking the mobile terminal keypad by the subscriber might also be used as a suitable trigger for this transmission.

In cases where it is necessary to make shall changes to the zone reliability and/or size, embodiments disclosed herein provide a convenient process. Assuming that the objective is to increase the reliability by a small margin against outages caused by re-selections to neighboring cells. A small increase in the assumed variation in the levels (sigma) can be applied and the serving probability calculation repeated. In this case, the larger sigma will cause cells having lower RxLevs to have an increased serving probability, typically meaning that brief reselection to one of these weaker cells whilst in the zone will attract a smaller cost and accordingly be less likely after filtering as described above, to result in a change to an OUT state. An alternative is to decrease the probability threshold used in the zone state decision.

Table 9 illustrates using the profile previously detailed in Table 5. In this case it is necessary to increase the zone extent slightly. The existing serving probabilities were calculated using a standard deviation of 9 dB. By increasing this to 11 dB for example and recalculating the probabilities as described previously we obtain the updated probabilities shown in Table 12 below.

TABLE 12

| Cell | RxLev | Serving |
|---|---|---|
| ID | (dBm) | probability |
| 1002 | −68.0 | 0.603 |
| 1011 | −79.3 | 0.200 |
| 1023 | −83.7 | 0.086 |
| 1003 | −85.9 | 0.061 |
| 1001 | −91.7 | 0.022 |
| 1031 | −93.6 | 0.015 |
| 1033 | −97.8 | 0.006 |
| 1021 | −98.3 | 0.006 |

It is desirable for zone detection systems operating in mobile radio networks to be resilient to changes in the radio network configuration. Such changes occur frequently as operators maintain and extend their networks. Because network configuration changes can alter the radio parameters measured by a user's terminal and in some cases the serving cell selection, it is desirable to adapt existing zone profiles to take account of such changes. Embodiments disclosed herein provide method for detecting when one or more parameters are changed in the radio network and updating existing profiles featuring affected cells. A radio propagation modeling tool can be used to predict the change in the signal power received within the zone arising from the network changes. The corresponding changes can be made to the power levels and the calculations described above repeated to obtain updated probabilities for each cell.

In the event that one or more new cells are added in the vicinity of a zone, a similar process can be followed, this time calculating signal level predictions for the new cells and obtaining an updated profile. In the relatively rare scenario where a cell which features in a profile is decommissioned, the same process can be followed with the updated radio network configuration model to obtain a new profile.

The following example illustrates a case in which the antenna orientation for one cell is altered. It is assumed that the updated network configuration information is supplied to the system in order to enable the adjustment to the profile. Also, the example assumes that there is an existing profile in the system as previously detailed in table 5.

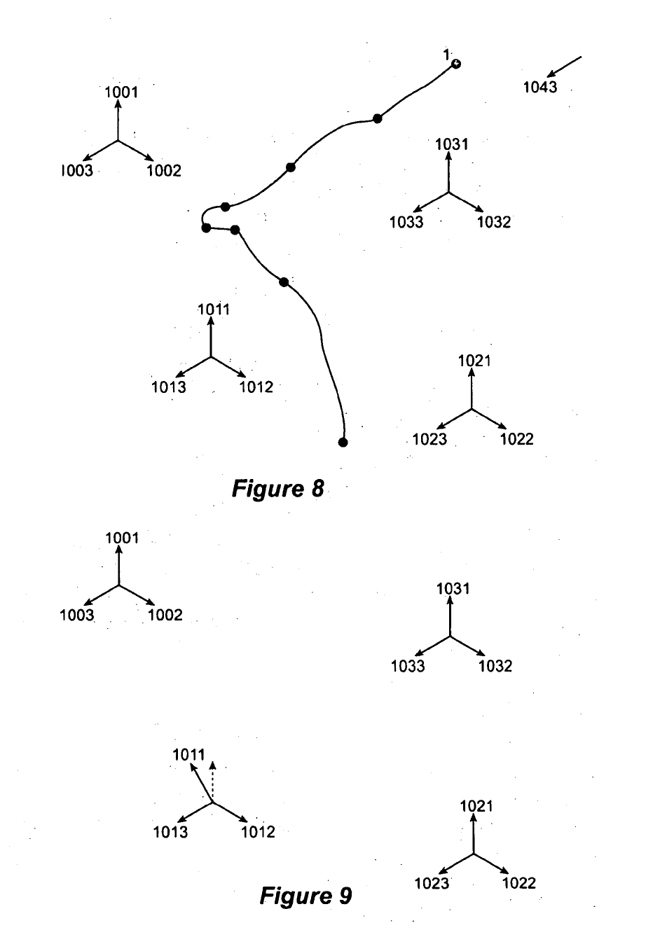

FIG. 9 shows the adjustment made in the network. The antenna for cell 1011 is rotated counter-clockwise by 30 degrees. The propagation model predicts the resulting effect on the received level at the centre of the zone is a decrease of 1.6 dB. Table 13 shows the updated profile.

TABLE 13

| Cell | RxLev | Serving |
|---|---|---|
| ID | (dBm) | probability |
| 1002 | −68.0 | 0.715 |
| 1011 | −79.3 | 0.148 |
| 1023 | −83.7 | 0.068 |
| 1003 | −85.9 | 0.044 |
| 1001 | −91.7 | 0.012 |
| 1031 | −93.6 | 0.007 |
| 1033 | −97.8 | 0.002 |
| 1021 | −98.3 | 0.002 |

The enhanced zone determination obtained by the various embodiments of the present invention may be useful in many applications. For example, it may be used to support zone-based charging for mobile-based telephone calls. In existing systems that require a location transaction for each call, the workload for the location system would be dramatically increased by such an application. In most cases, this increase would represent several orders of magnitude over the pre-existing usage. However, embodiments of the present invention allow this workload to be distributed to the mobile radio terminals, thereby minimizing an increase in the location systems' workload.

Issues with using conventional mobile location systems for use in differential charging may also arise from the latency associated with the location calculation. Typically, location systems may take several seconds or more to compute a location fix for a mobile. This delay typically increases with increasing volumes of location requests. By contrast, embodiments of the present invention would achieve much lower latency due to local zone determination.

Embodiments of the present invention may also be applicable to a buddy finder service. This type of service enables a group of mobile subscribers to register as a collective. At any time a member of the group can issue a request to the system to determine whether any of the other members of the group are nearby. An alternative to an immediate request is to register a request with a defined time period, for instance for the remainder of the evening.

Once a group of subscribers are registered, a user will typically contact the server to register a request, optionally specifying an expiry time for the request as well as a geographical proximity threshold. If the request is issued from a mobile terminal, the terminal may send back a set of measurements to a server. In such a case the server can develop a profile based on those measurements. The user may also issue the request via an alternative means, specifying a location or a region in geographic coordinates or civic address terms. On receipt of such a request, the server creates a profile based on either predicted data, historic profile data or a combination of both. The created profile can take into account the proximity threshold specified by the requester. The created profile can also take into account the location of the requester to which the requester subscribes, tailoring the profile to the environment. It is possible that members of a group will be subscribed to different mobile networks. In this case, the server uses tailors the profile for that each network.

Once the server has created a profile, this profile is then sent to the mobile terminal of other members of the buddy list. On receipt of a message bearing the profile, the application on the mobile terminal adds the profile to its current list of profiles. In the event that a member of the buddy list does not have a suitable application on the terminal, a text based message can be transmitted instead bearing a street and suburb oriented address informing the recipient that the user has requested notification of any buddies in that vicinity.

In the event that the application in one of the mobiles detects a match between the profile and the current filtered measurements, it will compose an alert message identifying the trigger criteria and containing the current filtered measurements. It will then transmit this alert message to the server. The server can then send a message to the original requester alerting him or her that a buddy has been identified who meets the requested criteria.

The server can also process the measurements, checking the result against the original criteria specified, by the user as well as the proximity threshold in order to reduce the risk of false alarm. This is because the server has greater processing power than the mobile terminal and also may have additional information.

The enhanced zone determination obtained by the various embodiments of the present invention may be useful in many other applications, including, but not limited to:
Self navigation (for example as an alternative to GPS systems);
Location Based Services (LBS) in which a telecommunications service provider can tailor communication and other services depending upon the subscriber's location at any one time;
Emergency/rescue location services;
Tracking of individuals, for example to alert a parent that her child carrying a mobile phone has traveled outside of a “safety zone” of a path between the child's home and the child's school;
Geographically-based entertainment and gaming applications;
Transport fleet management systems; and
Any other application where knowledge of the location of a mobile or a person associated with a mobile may be used.

The previously described embodiments of the present invention have many advantages. However, the invention does not require that all the advantageous features and advantages described be incorporated into every embodiment.

The first advantage is that high levels of reliability may be achieved within the zone with a dramatically smaller geographical extent. In other systems, the interplay between the in zone reliability and the leakage often requires a compromise. Due to the commercial importance of zone reliability, this compromise may require increasing the zone reliability by increasing the geographic extent of the zone. However, the resulting leakage is an attendant cost that must usually be borne. As described above, it is an advantage of this aspect of the present invention that for a specified in-zone reliability, the corresponding leakage can be made smaller than through existing techniques. Thus embodiments disclosed herein may facilitate implementation of smaller geographic zones:

Existing systems often exhibit re-selections when the mobile radio terminal is near the fringes of a zone due to the dynamically varying nature of the radio propagation environment. This occurs when the mobile radio terminal fluctuates between camping on a cell that is in the zone profile, and camping on a cell that is not in the zone profile. By filtering the determination of cell selection as described above, another advantage of embodiments of the present invention is that these fluctuations are minimized. Moreover, by reducing these fluctuations, aspects of the present invention reduce the associated signaling overhead that normally results.

A further advantage is that the reliability and leakage area can be traded off with significantly finer resolution than existing systems which rely primarily on serving cell information. In existing systems zone adjustments can be made only in units of a single cell, by adding or removing a cell from the list defining the zone. As described above, the present invention may allow the user to adjust the definition of a zone so as to increase or decrease the zone extent in more finely graduated steps.

Yet another advantage is that existing zone definitions can be adjusted smoothly in response to changes in the configuration of the radio network. As an example if the transmit power level of a cell near a zone is increased by a few decibels, the zone definition can be adjusted to take account of this change. Existing systems, however, can only be adjusted by adding or removing a cell in response to what may have been a very minor adjustment in the radio network configuration.

The invention has been described with reference to particular embodiments. However, it will be readily apparent to those skilled in the art that it is possible to embody the invention in specific forms other than those of the embodiments described above. This may be done without departing from the spirit of the invention. The embodiments are merely illustrative and should not be considered restrictive in any way. The scope of the invention is given by the appended claims, rather than the preceding description, and all variations and equivalents which fall within the range of the claims are intended to be embraced therein.

The reader's attention is directed to all papers and documents which are filed concurrently with this specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

1. A method for generating a profile representing a geographic region in a radio communications network comprising the steps of:
obtaining a probability for each of a plurality of cells that the cell will be selected as a serving cell by a mobile radio terminal in the geographic region; and
processing at least one probability to generate a profile representing the geographic region.

2. The method of claim 1 wherein obtaining a probability for each of a plurality of cells that the cell will be selected as the serving cell by a mobile radio terminal in the geographic region further comprises the steps of:
receiving a plurality of serving cell identities within the geographic region;
calculating a relative probability of receiving each serving cell identity; and
calculating an unmatched cell probability that represents the probability that the mobile radio terminal in the geographic zone might select a serving cell that was not a received cell identity.

3. The method of claim 1 wherein obtaining a probability for each of a plurality of cells that the cell will be selected as the serving cell by a mobile radio terminal in the geographic region further comprises the steps of:
determining a received signal power in the geographic region for each of the plurality of cells;
determining a signal power variation; and
calculating a probability for each of the plurality of cells that the cell will be selected as the serving cell by a mobile radio terminal in the geographic region based on the received signal power and the signal power variation.

4. The method of claim 3 further comprising the step of eliminating from the profile at least one cell, wherein said at least one cell to be eliminated has a probability of being selected as the serving cell that is below a threshold.

5. The method of claim 4 wherein the threshold is a complement of the zone reliability.

6. The method of claim 4 wherein the threshold is an unmatched cell probability.

7. The method of claim 4 wherein the threshold is based on a comparison between a predicted received signal power and a system limitation.

8. The method of claim 7 wherein the system limitation is receiver sensitivity.

9. The method of claim 1 further comprising the steps of:
receiving a plurality of serving cell identities within the geographic region;
calculating a relative probability of receiving each serving cell identity;
converting each relative probability into a relative received signal power;
determining a predicted signal power in the geographic region for each cell;
determining a signal power variation;
correcting the predicted signal power with the corresponding relative received signal power for each cell; and
calculating a probability for each cell that the cell will be selected as the serving cell by a mobile radio terminal in the geographic region based on the corrected signal power and the signal power variation.

10. A method for determining whether a mobile radio terminal is within a predefined geographic region comprising the steps of:
receiving a serving cell identity;
comparing a profile representing the predefined geographic region with the serving cell identity;
determining whether the mobile radio terminal is within the predefined geographic region based on the comparison;
calculating a cost associated with the received serving cell identity; and
comparing the cost with a zone detection probability threshold.

11. The method of claim 10 wherein the serving cell identity is received by a mobile radio terminal.

12. The method of claim 10 wherein the serving cell identity is received by a radio communications network device.

13. The method of claim 10 wherein the profile includes an unmatched cell probability and a probability for each of a plurality of cells that the cell will be selected as a serving cell by a radio terminal in the predefined geographic region.

14. (canceled)

15. The method of claim 10 further comprising the step of adjusting the zone detection threshold probability with a hysteresis offset.

16. The method of claim 10 wherein the cost is a probability that the cell corresponding to the serving cell identity will be selected as a serving cell by a mobile radio terminal in the predefined geographic region.

17. (canceled)

18. The method of claim 10 wherein determining whether the mobile radio terminal is within the predefined geographic region further comprises the step of applying a difference between the cost and the zone detection probability threshold to a filter to suppress short-term fluctuations.

19. A method of adjusting a profile representing a geographic region in a radio communications network, the method comprising the steps of:
obtaining a profile having a probability for each of a plurality of cells that the cell is selected as a serving cell by a mobile radio terminal in the geographic region;
adjusting a parameter of the profile; and
re-calculating a probability for each of the plurality of cells that each cell will be selected as a serving cell by a mobile radio terminal in the geographic region based on the adjusted parameter.

20. The method of 19 wherein the parameter is an assumed variation in signal levels.

21. The method of 19 wherein the parameter is a zone detection probability threshold.

22-23. (canceled)

24. A processor readable medium containing instructions to cause a processor to perform the method of claim 1.

25-30. (canceled)
